(19) United States
(12) Patent Application Publication
(10) Pub. No.: US 2004/0025649 A1
(43) Pub. Date: Feb. 12, 2004

(54) Wrench extension

(76) Inventor: Frederick P. Rugee, Graham, TX (US)

Correspondence Address: Frederick Rugee, 375 Country Club Dr. #7, Simi Valley, CA, 93065-6692, US

(21) Appl. No.: 10/213,751

(22) Filed: Aug. 6, 2002

(51) Int. Cl. B25B 23/16

(52) U.S. Cl. 81/177.2

(57) ABSTRACT

My invention, the WRENCH EXTENSION, is a simple device that extends the leverage of some common tools. It is very easy to use and is extremely usefull to plumbers and other workman. It is new, as there is nothing like it on the market—it will be of great help too many. I believe it will be as usefull as a can opener to many people.

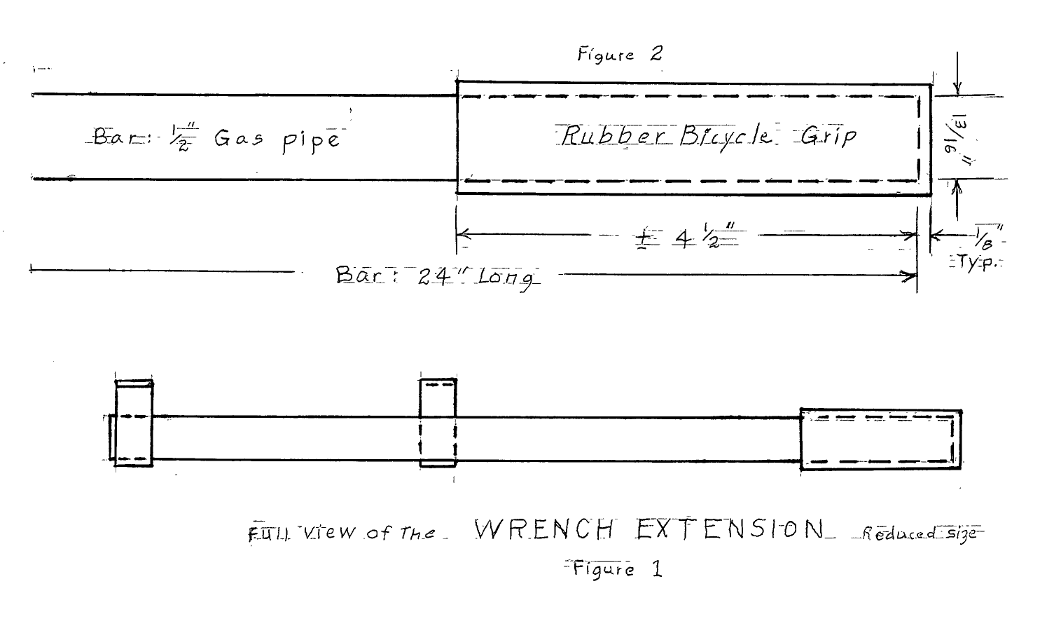

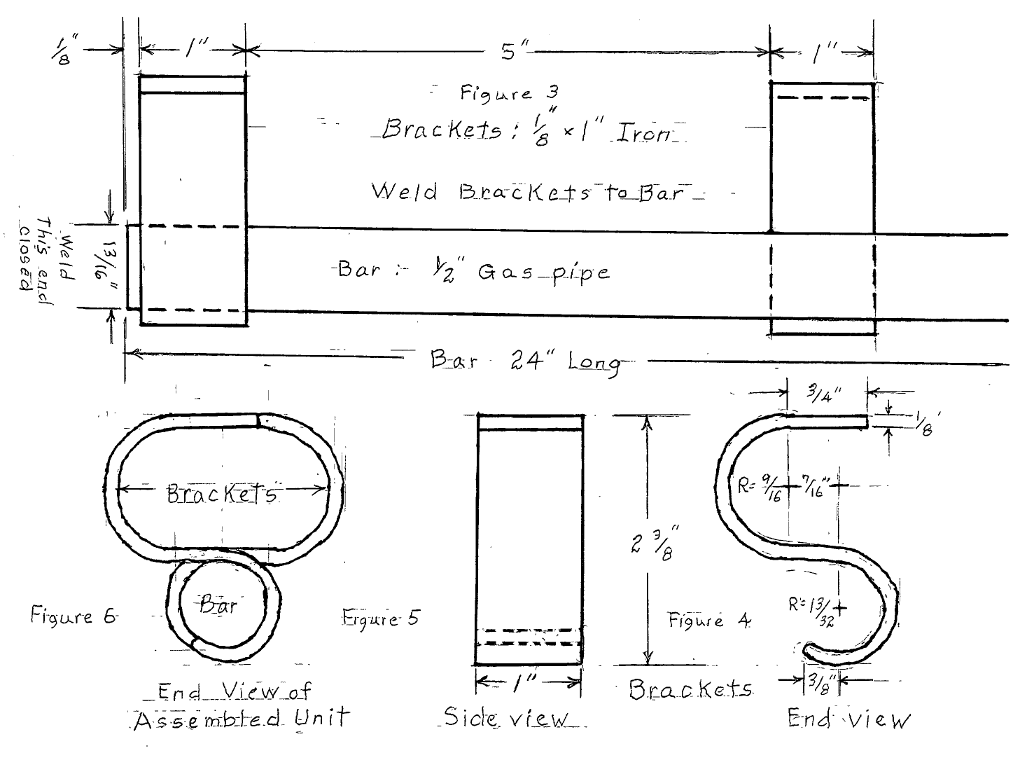

### I BACKGROUND OF INVENTION

One day, I was trying to remove a rusty piece of pipe from my water heater. I was unable to remove it with my 10 inch pipe wrench. I realized I needed more leverage—the idea of the WRENCH EXTENSION was born.

### II MAKING THE INVENTION

(a) The WRENCH EXTENSION starts with a piece of ½ inch gas pipe 24 inches long. This material is found in any hardware store or wholesale pluming supply house.

(b) Next, two brackets—made from ⅛″×1″ iron—need to be made. The iron stock is then heated and formed in the shape of an “S” and then cut to size. Each bracket takes about 5 inches of material. The iron is basic stock with iron suppliers and common stock in most welding shops.

(c) The brackets are then welded onto the 24 inch bar (gas pipe).

(d) The bar and bracket assembly are then spray painted.

(e) The rubber grip (a common bicycle handlebar grip) is then installed and the WRENCH EXTENSION is complete and ready for use.

### III Uses

I believe the WRENCH EXTENSION can be very effective with a pipe wrench, a crescent wrench, a socket wrench, and other common tools.

### SUMMARY

I believe the WRENCH EXTENSION is an original invention. I have never seen a tool such as this in any store. I feel it would be very useful for: plumbers,handymen, and home owners, etc. They all encounter those tough jobs—frozen rusty pipes, sticky tight values, tight bolts and nuts, that cannot be handled with the common wrench alone.

[image]

1. What I claim as my invention is the WRENCH EXTENSION. The WRENCH EXTENSION is solely my invention and belongs to no other. I have never seen nor heard of any device such as mine nor anything like it or similar to it—it is an original.
I plan to have my invention marketed, and feel as though I need patent protection against others who would put something similar on the market.
